(19) United States
(12) Patent Application Publication
(10) Pub. No.: US 2008/0062336 A1
(43) Pub. Date: Mar. 13, 2008

(54) Smart Zapper

(75) Inventor: Jacobus Dooms, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,263

(22) PCT Filed: Sep. 26, 2005
(86) PCT No.: PCT/IB05/53201

§ 371 Date: Mar. 29, 2007

(30) Foreign Application Priority Data
Sep. 30, 2004 (US) 60/614721

(51) Int. Cl. H04N 5/445

(52) U.S. Cl. 348/734

(57) ABSTRACT

An entertainment system includes a receiver having a tuner which is tunable to a various channels to receive various input signals. A controller is configured to generate a control signal to tune the tuner to a different channel. The controller detects an advertisement on the current channel, and generates the control signal to select a different channel in response to control criteria. The control criteria include similarity between the content programming of the current channel and the content programming of next channel to be tuned to. The similarity may be determined from analyzing the contents of the available channels, electronic program guide or metadata information included in the signal. The control criteria may also include the selected channel not having another advertisement. The control signal may be generated in response to detecting an advertisement on the current channel, or in response to a user action.

The present invention relates generally to selecting information and programs, such as selecting television programs for viewing.

There are many systems that include smart remote control units to control televisions including changing channels (or zapping) to a desired channel. The desired channel may be selected by the user, or selected based on predetermine criteria. For example, the user profile may influence the operation of the smart remote control unit, such as by defining a zap-circle of channels that include channels broadcasting a program with a positive rating in accordance with the user's profile. Such a system is disclosed in U.S. Pat. No. 6,493,688 B1 to Das et al., assigned to Koninklijke Philips Electronics N.V., which is incorporated herein by reference in its entirety.

Recommender systems are also known based on the profile of user(s), and include implicit and explicit recommender systems, as disclosed in co-pending U.S. patent application Ser. No. 09/666,401, filed Sep. 20, 2000, and entitled “Method and Apparatus for Generating Recommendation scores using Implicit and Explicit Viewing Preferences”, assigned to Koninklijke Philips Electronics N.V., the entire contents of which is incorporated herein by its reference.

Systems are also known that enable identifying and skipping commercials during recording and viewing prerecorded or buffered programs, including notifying a viewer who switched channels that a commercial has ended on a desired channel. Such systems are disclosed in U.S. 2003/0031455 A1 to Sagar, and WO 02/096102 A1 to Trajkovic et al. (U.S. patent application Ser. No. 09/862,278, filed May 22, 2001,) assigned to Koninklijke Philips Electronics N.V., which are incorporated herein by reference in their entirety. Further smart remote control systems include identifying channels broadcasting advertisement, or channels of no interest using pre-determined criteria, and temporarily excluding such channels from the pool of channels available for zapping, as described in GB 2392792A to Robertson, which is incorporated herein by reference in its entirety.

There is a need for an improved smart remote control system that dynamically determines and selects the next channel when zapping or changing channels, with minimal requirement, such as foregoing the need for a user profile.

According to one exemplary embodiment an entertainment system comprising a receiver having a tuner which is tunable to a plurality of channels to receive input signals. A controller is configured to generate a control signal to tune the tuner to different channel. The controller detects an advertisement on the current channel, and generates the control signal to tune the receiver/tuner to a different channel in response to control criteria. The control criteria include similarity between the content programming of the current channel and the content programming of next channel to be tuned to. The similarity may be determined from analyzing the contents of the available channels, electronic program guide or metadata information included in the signal.

The control criteria may also include the selected channel not having another advertisement. Further, the processor may be configured to return to the original channel when the advertisement ends on the original channel. Alternatively, processor may be configured to notify the user that the advertisement ended on the original channel.

The control signal may be generated in response to detecting an advertisement on the current channel, or in response to a user action, such as channel surfing, where the next selected channel in a smart zapping mode will include content similar to the current channel and/or will not be currently showing an advertisement. The smart zapping or channel surfing mode may be activated by the user by activating a key on the controller for example, where thereafter channel surfing would be in the smart mode. Alternatively, a key on the controller would change channels in the smart mode. The processor may be configured to dynamically detect and store a list of channels that includes content similar to the current channel and/or not currently showing an advertisement, and select the channels from this list when zapping in the smart mode.

The foregoing features of the present invention will become more readily apparent and may be understood by referring to the following detailed description of an illustrative embodiment of the present invention, taken in conjunction with the accompanying drawings. It should be expressly understood that the drawings are included for illustrative purposes and do not represent the scope of the present invention that is defined by the appended claims. The invention is best understood in conjunction with the accompanying drawings, where:

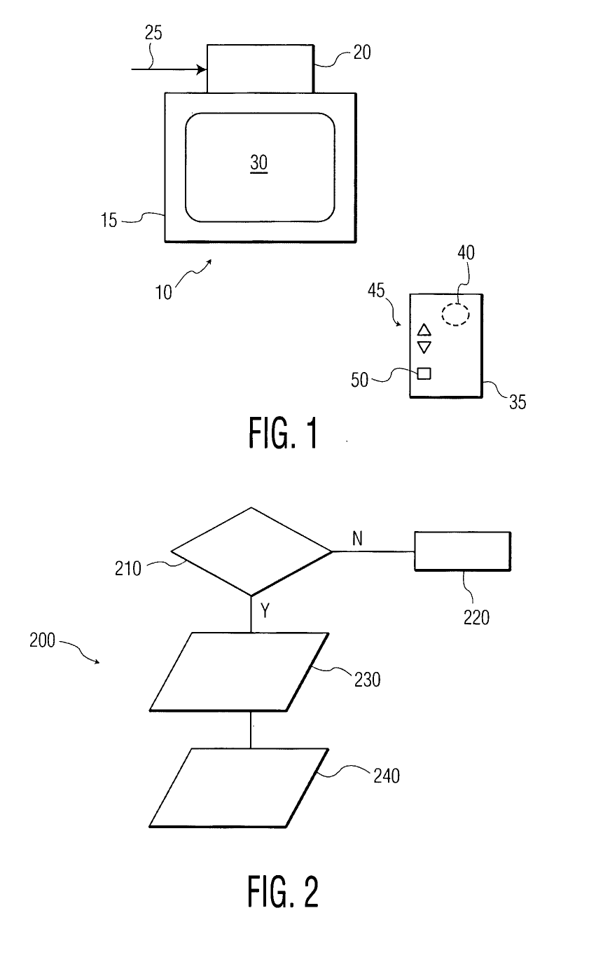

FIG. 1 shows a block diagram of a system according to one embodiment of the present invention; and

FIG. 2 is a flow chart showing operation of the system according to another embodiment of the present invention.

In the discussion to follow, certain terms will be illustratively discussed in regard to specific embodiments or systems to facilitate the discussion. As would be readily apparent to a person of ordinary skill in the art, these terms should be understood to encompass other similar known terms wherein the present invention may be readily applied. For example, the present invention will illustratively be described with regard to audio/visual content. This system would obviously also be applicable to strictly audio content, other content, or a mixture of audio and other types of content. Each of these and any other applicable systems should be understood to be within the scope of the appended claims.

For brevity, various details which are not directly related to the present invention, such as different content detection techniques are not included herein, but are well known in the art.

In accordance with an exemplary embodiment, FIG. 1 is a block diagram of an entertainment system 10 capable of automatically detecting commercials on channels and, in response to detecting the commercials and/or in response to channel browsing/zapping, selecting a channel with similar programming as the current channel, where optionally the selected channel is not currently airing a commercial. In particular, the system 10 includes a receiver 15, such as a television, having a tuner 20 which is connected to receive signals from an antenna or cable source 25 for display on a screen 30 of the television 15 for example. It is understood that the signal source 25 may be any source such as from broadcast or recorded sources received through any medium, such as air, telephone lines, optical fiber, cable and the like. The tuner 20 may be internal or external to the television receiver 15, such as an external set-top box, and is tunable to a plurality of channels to receive input signals. As is well known in the art, the tuner 20 tunes or selects an incoming signal which includes audio and/or video signals for example, where the selected signal is demodulated, decoded and forwarded for display on the screen 30, while the audio signal is forwarded to speakers.

The system 10 also includes a controller 35, such as a remote controller, having a processor 40 configured to generate a control signal to tune the tuner 20 to a different channel in response to activating channel up and down keys 45. As is well known, different types of memory are typically associated with the processor such as ROM and RAM memory for storing data and operating instructions. The processor 40 is also configured to place the system 10 in a smart-zap mode which may be activated using a separate smart key 50 for example which, upon activation, places the system in the smart-zap mode where the channel up and down keys 40 change the channels in this smart-zap mode. Alternatively, activation of the smart key 50 changes the channel in the smart-zap mode.

In the smart-zap mode which may be entered by activating the smart key 50 for example, in response to activation of the smart key 50 or the up/down keys 45, the processor 40 is configured to generate a control signal to tune the tuner 20 to a different channel showing content which meets certain criteria. The criteria include a similar content programming as the current channel and/or content that is not currently showing an advertisement or commercial. Alternatively, in the smart-zap mode, the processor is configured to automatically generate the control signal to tune to this different channel upon detection of a commercial on the current channel.

Commercials and content maybe detected by the processor 40 using various methods well known in the art, as disclosed in WO 02/096102 A1 to Trajkovic et al., WO 01/35409A2 to Christopher, and US 2003/0031455 A1 to Sagar which are incorporated herein by reference in their entirety. For example, commercial monitoring centers may be used as disclosed in U.S. Pat. No. 6,233,734 B1 to Macrae et al. which is incorporated herein by reference in its entirety.

Further, content classification method can be used to determine similarity of contents of the current channel and the selected channel to be tuned, as disclosed in U.S. Pat. No. 6,754,389 B1 to Dimitrova et al., assigned to Koninklijke Philips Electronics N.V., which is incorporated herein by reference in its entirety. In addition, event information tables (EIT) and/or meta-data included with the content and/or electronic program guide (EPG) may be used to identify commercials and/or similar content, as disclosed in GB 2392792A. For example, metadata may include information about programs, such as genre type, artists, title, rating, etc. as disclosed in US2001/0039571 A1 to Atkinson, which is incorporated herein by reference in its entirety.

EIT are included in digital video broadcasting (DVB) and have additional service information (SI) to assist the user in selection of services/events within the broadcast stream. EIT include information about a program present on an MPEG stream, where the EIT is transmitted or inserted into a program map table including program management information (PMT) as discussed in EP 1182881A2 to Sato, which is incorporated herein by reference in its entirety.

As shown in FIG. 2, operation 200 of the system includes detecting whether the smart-zap mode is entered 210. If not, then normal channel changing is performed 220 upon activation of the up/down keys 45. Otherwise, channels having similar content as the current channel and/or currently are not showing a commercial are detected 230. When up/down keys 45 or the smart key 50 is activated, or a commercial is detected on the current channel, then a different channel is tuned as detected previously, that is a channel showing similar content as the current channel and/or currently is not showing a commercial.

Determination and selection of the next channel may be performed dynamically, where detection of content of other channels begins upon determination to change channels, which may either be in response to a user command, or in response to detecting and a commercial on the current channel.

Alternatively, a list of channels showing current content is generated in advance of receiving the control signal for channel changing, and upon receiving the control signal, the current content of channels on the list are examined to determine that the current content is not a commercial or advertisement.

Finally, the above-discussion is intended to be merely illustrative of the present invention and should not be construed as limiting the appended claims to any particular embodiment or group of embodiments. Numerous alternative embodiments may be devised by those having ordinary skill in the art without departing from the spirit and scope of the following claims. For example, although the processor 40 is shown as included in the controller 35, the processor 40 may be in the tuner 20 or the receiver 25, or distributed throughout the controller 35, tuner 20, receiver 25 and/or other elements. Further, the processor 40 may be a dedicated processor for performing in accordance with the present invention or may be a general-purpose processor wherein only one of many functions operates for performing in accordance with the present invention. The processor may operate utilizing a program portion, multiple program segments, or may be a hardware device utilizing a dedicated or multi-purpose integrated circuit. Each of the above systems utilized for identifying commercials and content similarities may be utilized in conjunction with further systems, such as a system that includes a recommender, where the processor 40 communicates with the recommender to determine the next selected channel when zapping or to determine the channels of interest to be included in the list of desirable channels.

Further, the input signal may be prerecorded instead of a broadcast. For example, the input signal may come from a DVD-recorder, e.g., having hard disc. When watching a recorded movie coming form the recorder, either stored on a DVD or the hard disk of the DVD-recorder, the processor 40 is configured to detect commercials and skip them by stepping over commercials instead of tuning to a different channel. Thus, the processor 40 is configured to recognize that the input signal is coming form the recorder and generate a signal for the recorder to step over the commercials.

Thus, while the present invention has been described in particular detail with reference to specific exemplary embodiments thereof, it should also be appreciated that numerous modifications and changes may be made thereto without departing from the broader and intended spirit and scope of the invention as set forth in the claims that follow. The specification and drawings are accordingly to be regarded in an illustrative manner and are not intended to limit the scope of the appended claims.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function; and

e) each of the disclosed elements may be comprised of hardware portions (e.g., discrete electronic circuitry), software portions (e.g., computer programming), or any combination thereof.

1. A system comprising:
a receiver having a tuner which is tunable to a plurality of channels to receive input signals;
a controller configured to generate a control signal to tune said tuner to different ones of said plurality of channels, said controller being configured to detect an advertisement on a first input signal of said input signals received on a first channel of said plurality of channels, and generate said control signal to tune said receiver to a second channel of said plurality of channels for receiving a second input signal of said input signals in response to control criteria,
said control criteria including similarity between a first content programming of said first input signal and a second content programming of said second input signal.

2. The system of claim 1, wherein said similarity is determined from an electronic program guide or metadata.

3. The system of claim 1, wherein said similarity is determined from [analyzing the] contents of said plurality of channels.

4. The system of claim 1, wherein said control criteria further includes said second content not having another advertisement when tuned to said second channel.

5. The system of claim 1, wherein said control criteria further includes returning to said first channel when said advertisement ends on said first channel.

6. The system of claim 1, wherein said control criteria further includes notifying a user to return to said first channel when said advertisement ends on said first channel.

7. The system of claim 1, wherein said control signal is generated in response to detecting said advertisement.

8. The system of claim 1, wherein said control signal is generated in response to a user action.

9. The system of claim 8, wherein said user action includes activating a key on said controller.

10. The system of claim 1, wherein said controller is a remote controller and has a key that is configured to activate a smart channel surfing mode.

11. The system of claim 1, wherein said second channel is selectable by a user from a list of said plurality of channels recommended by said controller.

12. The system of claim 1, wherein said controller is configured to detect that a source of said first input signal is a playback unit and to skip said advertisement.

13. A method for selecting channels among a plurality of channels comprising:
detecting an advertisement on a current channel of said plurality of channels; and
tuning to a different channel of said plurality of channels for receiving an input signal that meet control criteria; said control criteria including similarity between a first content programming of said current channel and a second content programming of said different channel.

14. A computer program embodied within a computer-readable medium created using the method of claim 1.

15. A controller for a system comprising a processor configured to generate a control signal to detect an advertisement on a current channel of a plurality of channels; and to tune to a different channel of said plurality of channels for receiving an input signal that meet control criteria; said control criteria including similarity between a first content programming of said current channel and a second content programming of said different channel.
